(19) United States
(12) Patent Application Publication
(10) Pub. No.: US 2008/0201270 A1
(43) Pub. Date: Aug. 21, 2008

(54) Reserved tender advance facility

(76) Inventor: Joanne Marlowe-Noren, Wadsworth, IL (US)

Correspondence Address: Paul E. Schaafsma;NovusIP, LLC, Suite 221, 521 West Superior Street, Chicago, IL, 60610-3135, US

(21) Appl. No.: 11/708,815

(22) Filed: Feb. 21, 2007

(51) Int. Cl. G06Q 40/00

(52) U.S. Cl. 705/36 R

(57) ABSTRACT

A financial process in accordance with the principles of the present invention enables an amount of financing instruments to be credit enhanced. A reserved tender advance facility is established for an aggregate value minimally equal to the principal amount of debt to be undertaken. The reserved tender advance facility may be supplemented for first-loss or principal risk by the delivery of equity either in cash or in the form of an equity letter of credit. The reserved tender advance facility is maintained on standby until such time as a drawing made there under is received. Financing instruments, in reliance upon the credit-worthiness of reserved tender advance facility provider, are sold to eligible investors. Proceeds from the sale of the financing instruments are deposited in at least one account from which the proceeds will be invested in eligible investments. When a tender of the financing instruments is received, financing instruments obligation are directed for satisfaction of the tender and the financing instruments are remarketed for repurchase prior to the tender settlement date. In the event of a shortfall of remarketing proceeds, the reserved tender advance facility is drawn for the value of the shortfall.

### FIELD OF THE INVENTION

The present invention relates to a credit enhancement, liquidity, and cash-alternative investment vehicle that can act as a risk reserve management mechanism in conjunction with the operation of demand notes, bonds, commercial paper, and similar financial instruments.

### BACKGROUND OF THE INVENTION

The use of liquidity facilities as the basis to assure a marketplace for certain debt or equity instruments is a practice upon which many institutions and instrument issuers have relied in the past and continue to rely on today. This is a niche area within the financial marketplace that compensates financially capable firms for the application of their capital to certain potentially illiquid trading, transactional or investment markets. In exchange for being readily available to efficiently purchase, acquire or invest in certain instruments that are presented, the liquidity provider is compensated. The availability of certain liquidity is important in general terms as the basis to make and maintain trading or investment markets, provide stability to certain investment portfolios or create opportunity for the management of certain investments. Liquidity in any market—whether private or public—is critical to the stability of that market while participants in that particular arena may be shifting or changing. The importance of a liquid market or the presence of one or more ready liquidity providers is especially significant in circumstances in which a financial instrument has a particularly short-term, incorporates certain features that permit it to be ‘put’ back to the issuer for repurchase or otherwise may be redeemed on short notice.

For example, the pre-arrangement of liquidity to support the repurchase of shares of a closed-end mutual fund is important to the continuity and continuing good operation of that mutual fund in the event that a holder of mutual fund shares presents for redemption or otherwise tenders their shares back to the fund with an expectation of immediate purchase/redemption. Dependent upon the performance and state of the mutual fund, the fund operator may be able to immediately remarket those shares to an alternative party or otherwise purchase those shares with liquid capital on the fund operator's own books; however, in cases in which there is insufficient capital available or no third party ready to buy those shares, the mutual fund manager must be able to independently avail required funds to satisfy the shareholder that expects payment. Without a liquidity provider, the mutual fund would be forced to liquidate a portion of its portfolio, thereby disrupting the continuity of the portfolio and potentially causing unnecessary losses to the fund. Thus, the availability of liquidity to cover the repurchase or redemption costs associated with shares or financial instruments represents a foundational component of the operation of many investment instruments and markets.

In addition, the operation of a mechanism for the credit enhancement of an instrument, asset or company historically crosses over into a variety of markets, investments, credit vehicles, and general applications. The simplest interpretation of a ‘credit enhancement’ is the positioning of a qualified party with a superior credit standing as a guarantor of a financial obligation of a third party such that the credit standing of the third party is ‘enhanced’ to reflect the standing of the guarantor. This practice manifests in a variety of markets in a variety of forms; however, a credit enhancement is normally effectuated via the issuance of a formal payment instrument, such as for example a letter of credit or guarantee that stands behind a third party's obligation. One of the most readily and conventionally definable forms of credit enhancement is found within the banking community in a core banking practice: the confirmation of letters of credit.

For example, mainstream inter-bank credit enhancement practice begins with a bank wishing to issue a letter of credit in support of a designated and approved client transaction. For purpose of illustration, assume the commercial credit standing of the letter of credit issuing bank is not of sufficient quality to the proposed beneficiary of the letter of credit. As the basis to support or to credit enhance its letter of credit, the letter of credit issuing bank can utilize a third party bank that has a better and more acceptable credit standing to tender a full confirmation of the issuing bank's letter of credit, thereby causing the confirming bank to adopt the issuing bank's payment obligation as its own under the terms of the letter of credit. Generally, certain consideration is paid for the confirming bank's credit enhancement, and the confirmation is supported by a separate credit arrangement between the two banks rather than by the confirming bank's assumption of a direct collateral position on the assets of the issuing bank.

As a further example of credit enhancement practice, a commercial entity may wish to issue commercial paper, demand notes, bonds or other similar instruments for sale to investors. The issuer of the financial instrument may be credit worthy or be sufficiently supported by assets; however, its credit quality may not be sufficient to entice investors to purchase its financial instruments without some direct and definable credit support of its obligation by a credit-rated firm. In such cases, a commercial lender may elect to take a secured position on the assets or other collateral of the issuer of the financial instrument or otherwise arrive at an acceptable credit agreement, receive a fee from that party, and cause the issuance of a direct-pay letter of credit, payment undertaking, guarantee or similar financial instrument or undertaking as the basis to directly guarantee the obligations of the financial instrument. This is generally the practice employed to enable certain types of securitizations of debt obligations or credit underwriting that has been adopted in relation to the issuance and credit enhancement of variable rate demand notes, bonds, some types of commercial paper, and other similar financial instruments.

Finally, an investor that is seeking to support an investment via a mechanism or vehicle that does not call for a direct cash allocation in favor of the recipient has generally acted to provide a credit (letter of credit), negotiable security or other asset against which a draw could be made or an independent credit line could be established by the recipient. This practice is simple and easily defined; however, it calls for both the incurrence of conventional credit costs, interest, and charges associated with the establishment of credit by either the applicant/investor or beneficiary/recipient. Those costs can be onerous or otherwise foster a circumstance which makes the investment unattractive or impractical. Additionally, the party making an investment using this type of vehicle may be calculating its rate of return based upon the current or actual value of the security, asset or instrument delivered whereas the available proceeds for investment by the recipient can cause less than that market value of the collateral/security/instrument to be available for use by the credit recipient. This can occur for example due to discounts, loan to value restrictions or other similar reductions calculated against the market value of the collateral/security/instrument. These issues ‘raise the bar’ on the effectiveness or attractiveness of this type of non-cash based/cash-alternative investment vehicle/mechanism from the recipient's perspective while potentially reducing the rate of return on investment to the party who has availed the asset for use and investment purposes to the recipient.

This approach to creating a cash-alternative investment vehicle, although at times practicable, by nature breeds investment inefficiencies. Initially, loan to value considerations can reduce available capital that may be applied to the intended investment recipient which ultimately reduces investment performance. In addition, market-driven costs associated with the operation of credit facilities must be established to ‘marry up’ to the cash-alternative investment instrument/vehicle. This produces a baseline cost of credit/capital ‘hurdle’ which directly nets out against a substantial portion of investment yield or earnings. When taken together, a traditionally formatted, non-cash/cash alternative investment is potentially hindered by the combination of reduced value of principal assets/cash made available for investment and a market-based cost of credit associated with that reduced principal amount of proceeds. Therefore, although there are a variety of ways in which a cash-alternative investment vehicle or mechanism may be employed, in prior art incarnations the factors identified above oftentimes made this type of vehicle cost prohibitive and yield restrictive for the participants.

In today's financial marketplace, there are a variety of unrelated means to address liquidity, credit enhancement, and the establishment of cash-alternative investment mechanisms. However, in the prior art, except in highly specialized circumstances there is no single facility that readily accomplishes these functions effectively without creating a cost prohibitive financial model.

Additionally, there are certain institutional, regulated investors that are subject to prevailing risk-based capital (RBC) reserve requirements and similar risk or loss reserve stipulations. These reserve requirements are established by a variety of United States-based and international regulatory bodies such as for example the National Association of Insurance Commissioners (NAIC), 2301 McGee Street, Suite 800, Kansas City, Mo. 64108. These reserve requirements oftentimes serve as one of the factors to be considered when an institution is evaluated for a credit rating review by a rating agency. The establishment of a standardized categorical scale of RBC reserve requirements is designed to assure that the institution has sufficient reserves available to offset potential future losses. The reserve scale has been established in general by an examination of certain transactional and investment factors such as the nature of the investment opportunity or recipient, the nature of the investor, and the perceived liquidity or illiquidity of the investment itself, among other things. Due to a necessarily broad categorical profile of RBC reserve requirements, institutions that are subjected to these standards often times are unable to cost-effectively invest in well-suited and targeted investment opportunities because of the economic impact of RBC reserve stipulations and the nature of how those reserves must be set aside.

As a practical matter, RBC reserves can cause the investor to not only allocate the funds that are to be directly invested—customarily in cash or a cash equivalent—but to also set aside from working or operating capital a percentage of the principal amount of the investment as the source of the RBC reserve. The funds that constitute the RBC reserve therefore create a drag on operating capital, cannot be actively or aggressively invested while held in reserve, and may be necessarily accounted for in such a way as to result in that capital having relatively little positive impact on the investor's operations. These factors represent a high ancillary cost to investing or otherwise allocating capital to certain types of generally attractive and prudent investments, thus requiring those investments to perform at a substantially superior rate to market simply as a means of ‘breaking even’ on cost of capital. In some cases, the impact of RBC reserve requirements on other components of the investor's balance sheet and capital availability makes an otherwise viable investment impracticable. Thus, a regulatory compliant means of risk managing these investments in order to prudently ‘step down’ the economic impact of related RBC reserve requirements would represent a valuable investment risk management tool to these institutional investors.

As an example of how RBC reserves are generally assessed and how RBC reserves can impact an institutional investor, an evaluation of how this system generally manifests within the context of the U.S.-based insurance industry is helpful. The NAIC established a categorical scale defining the nature of certain types of securities/investments from 1-9, with category 1 representing lowest reserve requirements and category 9 representing highest reserve requirements. Each category is assessed a standard percentage-based RBC reserve charge and a profile of the types of investments that fall into each category. Practically speaking, an insurance carrier may be subjected to reserve requirements scaled at anywhere between no reserve requirements, or 0%, for cash or cash equivalent investments to reserve requirements of up to 30% of capital invested for illiquid/longer term/higher risk investments. Examples of such high reserve requirements include private equity or alternative investment funds/hedge funds. The insurance carrier then examines the nature of and assigns its investment holdings into the appropriate category. The value of assets in each category is then multiplied by the percentage RBC rate assessed to that category. The sum of those products is equal to the amount of money that the insurance carrier must set aside from operating capital into a Securities Valuation Reserve Account (“SVRA”) to cover the insurance carrier's minimum RBC reserve requirements for their specific investment holdings. Capital credited to the SVRA is off-limits for use in operations by the carrier.

Additionally, general practices for an insurance carrier call for the carrier's crediting of their unallocated surplus capital into the SVRA. When an insurance carrier is subjected to a credit rating review by a credit rating agency, the rating agency looks at what is minimally required to be in the SVRA as a foundational component of the rating process. If the minimum capital required to cover RBC reserves is not credited to the SVRA, the carrier is generally diagnosed as having a liquidity issue, but in practical terms may be considered insolvent because its available capital in reserve is not sufficient to offset assessed risks associated with its holdings. This could result in serious repercussions to the carrier, inclusive of financial failure. Carrying this forward to a less draconian example, if a carrier wishes to maintain or achieve a high credit rating, such as a “AA” rating by Standard & Poor's Ratings Services, 55 Water Street, New York, N.Y. 10041, capital reserved within the SVRA would generally tally an estimated two times the minimum amount of capital required to be held in reserve per the RBC reserve calculations set forth above. In light of this profile, a pro-active means of better compliantly managing the nature and categorization of investments held by an insurance carrier would have a positive impact on the assessed credit worthiness of the carrier.

Thus, in today's environment, with no consistent methodology for RBC reserve management readily available to an insurance company or similar institution governed by these type of reserve guidelines, the institution has limited flexibility in building a more efficient, productive, and effective investment portfolio or profile, even when prudent risk management tools have been applied and beneficial investment opportunities have been identified. As such, in most cases, the investor will simply refrain from making any investment—in cash or otherwise—that would subject it to an RBC reserve assessment in one of the higher categories. Simply put, the perceived benefits of making such an investment is so reduced or stifled by the impact of the reserve requirements on other aspects of the investor's operation, the investment would have to generate excessive returns—and likely incur excessive risk to so do—in order to bring the investor's rate of return into an acceptable margin.

At present, although there are case-specific investment regulatory reviews of specific investments available to regulated entities, these industry-based reserve requirements generally do not exhibit the same flexibility in construction as the investment marketplace does to take into account sophisticated, quality, and widely-used investment risk management and mitigation tools. Additionally, these regulated investors operate in an investment environment with little in the way of standardized reserve management tools to mitigate the indirect impact of applicable RBC reserve requirements and associated costs of capital. What is thus needed is a mechanism that can compliantly and consistently manage and reduce RBC reserve requirements by better and effectively managing and stepping down the categorical risk reserve assessments applicable to certain prudent investment vehicles and instruments.

### SUMMARY OF THE INVENTION

A financial process in accordance with the principles of the present invention compliantly and consistently manages and reduces RBC reserve requirements by better and effectively managing and stepping down the categorical risk reserve assessments applicable to certain prudent investment vehicles and instruments. A financial process in accordance with the principles of the present invention enables an amount of financing instruments to be credit enhanced. A reserved tender advance facility is established for an aggregate value minimally equal to the principal amount of debt to be undertaken. The reserved tender advance facility may be supplemented for first-loss or principal risk by the delivery of equity either in cash or in the form of an equity letter of credit. The reserved tender advance facility is maintained on standby until such time as a drawing made there under is received. Financing instruments, in reliance upon the credit-worthiness of reserved tender advance facility provider, are sold to eligible investors. Proceeds from the sale of the financing instruments are deposited in at least one account from which the proceeds will be invested in eligible investments. When a tender of the financing instruments is received, the financing instruments are remarketed for repurchase prior to the tender settlement date.

In the event the remarketing fails prior to the tender settlement date, a shortfall of remarketing proceeds required to satisfy the tender occurs. In such event, the reserved tender advance facility is drawn for the value of the shortfall. A lien is secured against the tendered financing instruments and may be secured against related and underlying eligible investments, with such lien made active upon the disbursement of the corresponding reserved tender advance amount as the basis to satisfy the tender. Proceeds required to satisfy the tender are disbursed, those financing instruments that have been repurchased with proceeds derived from the reserved tender advance facility for the benefit of the underwriter are held, once the tendered financing instruments are successfully remarketed, the remarketing proceeds are onwarldy advised to reimburse amounts drawn under the reserved tender advance facility, and the lien established in support of the previously advanced amount is released.

### BRIEF DESCRIPTION OF THE DRAWINGS

FIG. 1 is a methodological schematic depicting a general overview of the operation of a liquidity component in accordance with the principles of the present invention.

FIG. 2 is a methodological schematic showing the use and application of an example interim reserved tender advance facility inclusive of the liquidity component of FIG. 1.

FIG. 3 is a methodological schematic showing the use and application of an example commercial reserved tender advance facility inclusive of the liquidity component of FIG. 1.

FIG. 4 is a methodological schematic showing the use and application of an example collateralized reserved tender advance facility inclusive of the liquidity component of FIG. 1.

FIG. 5 is a methodological schematic showing the use and application of an example principal reserved tender advance facility inclusive of the liquidity component of FIG. 1.

FIG. 6 is a methodological schematic showing the issuance and use of an equity letter of credit inclusive of the liquidity component of FIG. 1.

### DETAILED DESCRIPTION OF THE INVENTION

In looking at the individual market functionalities of providing liquidity, credit enhancement, and cash-alternative investment mechanisms in their prior art incarnations, each of these exhibit commercial benefits and usefulness in support of their respective and active applications in the marketplace. Although these components are all individually useful, however, in accordance with the principles of the present invention there is significant potential for the whole to be synergistically greater than the sum of the individual parts.

By unifying these features into a single, revenue-generating mechanism of the present invention, it has been surprisingly found that a new and efficient financial mechanism is provided for use by traditional financial service providers, financial institutions, and other institutions that may not be subject to regulated reserve requirements. When this mechanism is further overlaid into the investment environment of an institutional investor that is subjected to certain fixed RBC reserve requirements related to its investment portfolio, however, that investor simultaneously and additionally benefits from a new ability to proactively manage those reserve requirements and potentially strengthen or enhance its financial profile. While not so limited hereunder, the combination of these seemingly divergent features of liquidity, credit enhancement, and a cash-alternative investment vehicle is preferably enabled when utilized in association with the application of credit proceeds derived from the coordinated issuance of a compatible debt instrument. All of these factors, when taken together, create a new and more efficient class of financial product to meet targeted needs of certain investors and borrowers.

What is thus proposed is a new and more flexible type of financial product, non-limitedly referred to herein as a reserved tender advance facility, that can be applied in a variety of market conditions as the basis to produce broader and more efficient results for users, operators, and underwriters. In accordance with various embodiments of the present invention described in detail below, an interim reserved tender advance facility can act as a liquidity/credit enhancement facility or as a liquidity/credit/cash-alternative investment vehicle in direct association with a short-term asset management market; a commercial reserved tender advance facility can act as a liquidity/credit enhancement facility in support of the operation of a warehoused credit facility or other revolving commercial credit function; a collateralized reserved tender advance facility can act as a liquidity/credit enhancement/leverage-credit surrogate to an asset management or fund functionality; and a principal reserved tender advance facility can act as a liquidity/credit enhancement/cash alternative investment vehicle/RBC reserve management tool.

The reserved tender advance facility is paired opposite a coordinated and complementary capital source which can be in the form of the issuance of notes, bonds or other types of commercial paper or the establishment of certain credit facilities. While not so limited hereunder, in a preferred embodiment the reserved tender advance facility can be paired with lower-cost hybrid financial instruments such as for example variable rate demand notes, collateralized variable rate demand notes, managed variable rate demand notes or other similar instruments which incorporate a call/put option that qualifies a long term debt instrument or facility for short-term pricing. Examples of such instruments are described in U.S. patent application Ser. No. 10/400,211 titled “Investment Grade Collateralized Variable Rate Demand Notes” filed 27 Mar. 2003; U.S. patent application Ser. No. 11/038,804 titled “Collateralized Variable Rate Demand Notes as a Leverage Supplement” filed 20 Jan. 2005; and U.S. patent application Ser. No. 11/253,337 titled “Investment Grade Managed Variable Rate Demand Notes” filed 19 Oct. 2005, the disclosures of which are hereby incorporated by this reference. Such a pairing holds the potential for improved credit pricing and advantage to the borrower as the issuer of the debt/financial instrument by making use of the unique commercial capabilities inherent in the nature of the reserved tender advance facility systems and applications.

The implementation of the reserved tender advance facility of the present invention promotes several potential benefits to the participating parties. When subject to risk-based capital (RBC) reserve requirements, a reserved tender advance facility underwriter can benefit from new fee-based revenue sources and investment exposure with the potential for enhanced investment returns. The reserved tender advance facility underwriter also can enjoy reduced reserve requirements due to compliant and managed reductions in the categorization of certain subject investments. For the borrower or financial instrument issuer that pairs the source of debt capital with the operation of the reserved tender advance facility, enhanced and improved debt pricing can become available with potentially more attractive terms than conventional credit or leverage facilities might provide. For an investment recipient—which may be for example an alternative investment fund, a fund of funds, a hedge fund or another qualifying investment vehicle—a new cash-alternative investment tool can become available that opens up new sources and profiles of potential qualified investors. Not only that, but the new cash-alternative investment tool can do so in a way that makes the investment more attractive to the institutional and regulated investor by better managing associated RBC reserve requirements that otherwise might prove detrimental to investor participation.

Further, the implementation of the present invention can create a mechanism that may be applied in the market in order to actively manage RBC reserve requirements. By so doing, the present invention can create new opportunities to enhance the benefits to a credit enhancing party beyond the aggregate benefit of liquidity fee earning potential, credit enhancement fee generation, and investment yield participation in a desirable investment opportunity or profile. Not only that, but this mechanism of the present invention can also manage a critical risk reserve component which has been inherently cumbersome to select investor types when seeking to effectuate investments in certain asset classes.

A financial process in accordance with the principles of the present invention can be established by a suitable guarantor on a contingent basis, having limited reserve requirements and in several different manifestations that may be applied to a variety of different commercial and investment opportunities in the capital markets and alternative investment/hedge fund investment markets. As described in detail below, a financial process in accordance with the principles of the present invention can be established as an interim reserved tender advance facility, a commercial reserved tender advance facility, a collateralized reserved tender advance facility, a principal reserved tender advance facility or the like, with the type of reserved tender advance facility being distinguished depending upon its intended application profile within the financial marketplace and the nature of the underlying investment operations, commercial activities, and/or collateral structures.

A financial process in accordance with the principles of the present invention can be used to generate substantial pools of debt-based capital by commercial borrowers, investment funds, hedge funds, lenders or investment banks as the basis to enhance and supplement available equity funding, whether in the form of cash or financial instruments. A financial process in accordance with the principles of the present invention can be coordinated with cash as equity or a letter of credit as an equity alternative to offset first-loss risk and/or principal risk associated with the application and use of proceeds arising from the sale or placement of a financial instrument, debt obligation, credit facility or other financing instrument that is supported by the credit enhancement constituted by the operation of the present invention. When in the form of a letter of credit, the equity alternative can be referred to as a “reserved tender advance facility equity letter of credit” or “equity letter of credit”.

A financial process in accordance with the principles of the present invention can create an opportunity for a third party investor to provide the equity or equity alternative component to cover first-losses or principal risk associated with the operation of commercial activities, investment strategy or asset management strategy undertaken with debt proceeds resultant from the issuance of a financial instrument, debt obligation, credit facility or financing instrument as credit enhanced by the operation of the present invention. A financial process in accordance with the principles of the present invention creates an opportunity for the third party investor to participate in yield generated by the borrower resultant from its use of financing proceeds on a leveraged basis without necessarily incurring the corresponding leverage risk that would normally be associated therewith or negotiate a minimum fee payable for the first-loss or principal risk exposure being taken.

A financial process in accordance with the principles of the present invention can be applied as a credit enhancement—upon which credit rating reliance may be placed in support of a financial instrument, debt obligation or other such financing instrument—without the guarantor being required to issue an operative financial instrument such as a letter of credit, bank guarantee, corporate guarantee or other similar financial undertaking as the basis of such credit enhancement. A financial process in accordance with the principles of the present invention may be established in two or more parties that permits one of those parties or a third party to draw upon the guarantor for certain liquidity up to the full principal value of the financial instrument, debt obligation or other financing instrument, plus interest, if desired.

A financial process in accordance with the principles of the present invention can be applied to provide short-term or long-term liquidity in response to optional or mandatory tenders, redemptions or other instrument characteristics that would require the repurchase or redemption of the financial instrument, debt obligation or other such financing instrument in support of which the present invention has been applied as a credit enhancement. A financial process in accordance with the principles of the present invention can be applied to maintain the integrity and continuity of underlying and associated investment operations, commercial activities, and/or collateral structures to which proceeds of the financial instrument, debt obligation of other similar financing instrument have been applied.

A financial process in accordance with the principles of the present invention can be utilized as a cash-alternative investment mechanism in which the guarantor of the financial instrument, debt obligation or other similar financing instrument in support of which the present invention has been applied can gain exposure to and yield participation in the investment operations, commercial activities, and/or collateral structures to which proceeds of the financial instrument, debt obligation or other similar financing instrument has been applied. A financial process in accordance with the principles of the present invention has a component of first-loss or principal risk associated with the provision of liquidity and corresponding credit enhancement of minimally the principal amount of financial instrument, debt obligations, and other similar financing instruments in support of which the present invention has been applied. A financial process in accordance with the principles of the present invention can create an opportunity for the guarantor or other related or coordinated entity that assumes the first-loss or principal risk associated with the investment operations and/or commercial activities to which proceeds have been applied to gain exposure to and participate in a comparable manner as an equity investor in such underlying investment operations or commercial activities without having actually invested its own capital.

In its interim reserved tender advance facility embodiment, a financial process in accordance with the principles of the present invention can create a means by which principal value can be supported while an asset manager is utilized on an interim basis—between the date of instrument issuance or capital availability and the date of commercial application of either financial instrument or credit proceeds—in coordination with the intended application of the financial instrument, debt obligation or other financing instrument proceeds to a commercial operation. In its interim reserved tender advance facility embodiment, a financial process in accordance with the principles of the present invention can assist a commercial borrower in effectively offsetting negative carry or accrued interest before the commercial borrower applies the credit proceeds to its scheduled commercial operations. This can be accomplished through the temporary allocation of the proceeds to the care, custody, and management of an asset manager that is supported by a minimal principal value credit enhancement of an interim reserved tender advance facility provider (as guarantor), thus enabling the borrower to be secure in the avoidance of principal losses that may be accrued or incurred by the asset manager.

In its commercial reserved tender advance facility embodiment, a financial process in accordance with the principles of the present invention can enable a commercial borrower as the direct or indirect issuer of a financial instrument, debt obligation or other financing instrument to deposit its credit proceeds in a designated custodial or transacting account as established with or for the collateral benefit of the reserved tender advance facility provider or its nominee wherein the borrower will conduct certain approved transactions which permit the substitution of collateral acceptable to the reserved tender advance facility provider for credit proceeds held on such account. In its commercial reserved tender advance facility embodiment, a financial process in accordance with the principles of the present invention can function as a revolving credit facility, which is initially funded by the proceeds of the financial instrument, debt obligation or other financing instrument as issued either directly or indirectly by the commercial borrower and supported by the credit enhancement of the commercial reserved tender advance facility provider (as guarantor), but which may be recycled through a variety of individual transactions which conform to a core commercial underwriting or management guideline that has been agreed between the reserved tender advance facility provider and the borrower as the issuer of the credit enhanced financial instruments or credit obligations.

In its collateralized reserved tender advance facility embodiment, a financial process in accordance with the principles of the present invention acts as a de facto alternative to a conventional investment leveraging mechanism comparable to a collateralized fund obligation in support of the debt portion or other credit component of an investment fund, hedge fund, fund of fund or other similar alternative investment of asset management vehicle. In its collateralized reserved tender advance facility embodiment, a financial process in accordance with the principles of the present invention can complement an equity component of such a fund in the form of a letter of credit or cash deposit estimated at a value equal to such amount as may be deemed acceptable to the collateralized reserved tender advance facility provider as a percentage of the principal amount of financial instruments, debt obligations, credit granted or other financing instrument issued as such is issued or provided for the benefit of the reserved tender advance facility provider (as guarantor) covering first-losses or a minimum agreed amount of principal risk associated with the operation of the fund. In its collateralized reserved tender advance facility embodiment, a financial process in accordance with the principles of the present invention potentially decreases credit costs to the fund thereby increasing yield to the underlying equity investors or limited partners of the fund without necessarily passing leveraged exposure or risk through to the fund's equity investors or limited partners.

In its principal reserved tender advance facility embodiment, a financial process in accordance with the principles of the present invention permits the guarantor of the reserved tender advance facility to explicitly assume first-loss and/or principal risk associated with the investment management of the proceeds arising from the sale or placement of the financial instrument, debt obligation, credit facility or other financing instruments as the basis to gain investment exposure to the investment operation of the borrower as an investment fund, alternative investment fund, hedge fund or other investment opportunity approved or accepted by the reserved tender advance facility provider. In its principal reserved tender advance facility embodiment, a financial process in accordance with the principles of the present invention enables a cash-alternative investment opportunity for the guarantor of the reserved tender advance facility as a surrogate investor in the investment. In cases in which the reserved tender advance facility provider (as guarantor/investor) is subject to RBC reserve requirements, those reserve requirements may be reduced or better managed upon application of the principles of the present invention when the nature of investments undertaken is characterized as an investment fund, alternative investment fund, hedge fund or other similar investment opportunity. In its principal reserved tender advance facility embodiment, a financial process in accordance with the principles of the present invention can, by reducing or better managing RBC reserved requirements, enhance investment performance for the reserved tender advance facility as the investor/guarantor of the financial instrument issuer/borrower's investment or fund activities.

When used in coordination with an independent source of capital, the financial process of the present invention can increase functional efficiencies and profitability for the provider of the present invention while decreasing costs to the users of the present invention as borrowers, financial instrument issuers or the beneficiary of certain structured credit mechanisms. When applied for use by financial institutions as the providers of the mechanism that are subject to the assessment of RBC reserve requirements, the financial process of the present invention provides those institutions with a means to reduce or otherwise better manage those reserve requirements such that certain investments that otherwise would have been cost prohibitive may be undertaken and rates of return may be enhanced.

In one embodiment, the financial process of the present invention can be enabled or potentially expanded by the incorporation of an equity component in the form of cash or a specifically formatted letter of credit. This equity component is drawable by or otherwise available to the market provider of the present invention as the basis to offset first-loss or principal risks associated with the use, management or operation of the proceeds/capital raised or otherwise made available in coordination with the application of the present invention. Further, this equity component may for example be provided by: a third party for the purposes of participation in yield generated resultant from the use, management or operation of the proceeds/capital raised or otherwise made available in coordination with the application of the present invention; the issuer of the financial instruments, borrowers under the credit facilities or the beneficiary of the capital that has been coordinated with the application of the present invention such that they enhance or otherwise better preserve their net profit from the yield generated resultant from the use, management, investment or operation of the proceeds/capital raised; or the market provider of the present invention as the basis to gain investment exposure into the use, management, investment or operation of the proceeds/capital raised.

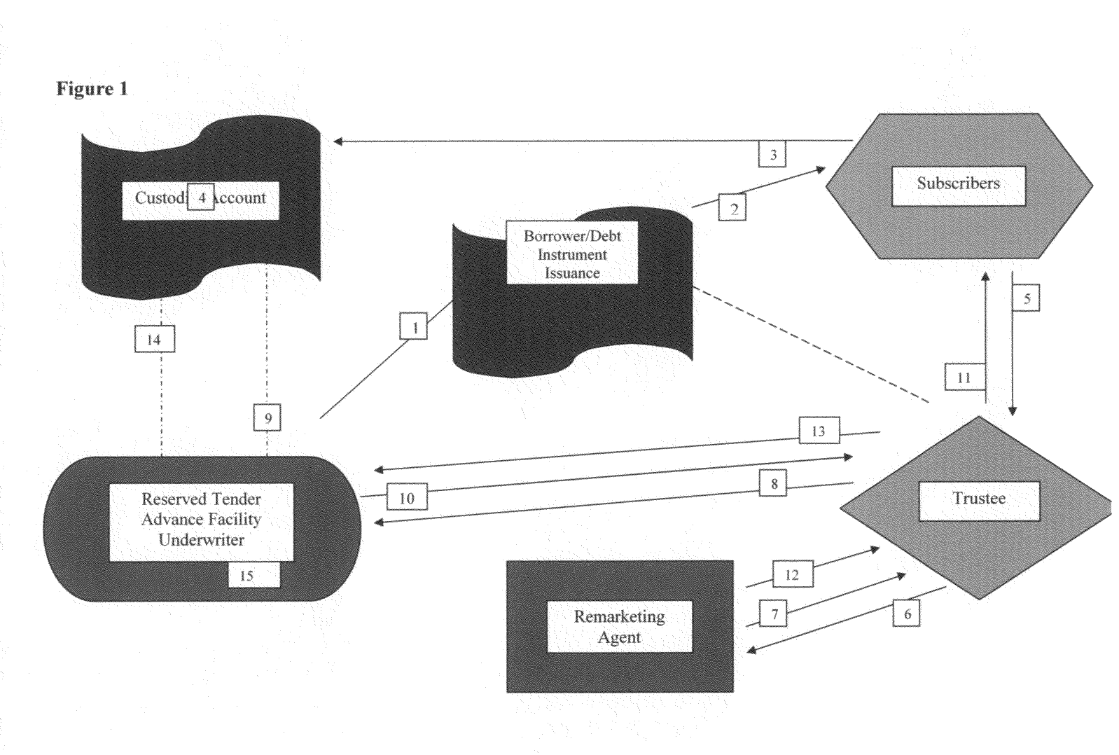

Referring now to FIG. 1, a methodological schematic is seen depicting a general overview of the operation of a liquidity component that enables a principal amount, plus interest if desired, of financial instruments, debt obligations, credit facilities or other financing instruments to be credit enhanced in accordance with the principles of the present invention. For the purposes of illustration and not limitation, a convertible instrument possessing a call/put function that could permit optional or mandatory tenders upon notice is referenced; however, any financing instrument that may be subject to early or interim tender, redemption or any other similar circumstance that could require its remarketing and the operation of corresponding liquidity facilities could be used. Initially, an issuer of a financial instrument or ‘borrower’ (1) establishes a credit enhancement/liquidity facility in the form of a reserved tender advance facility with one or more credit worthy financial institution(s), bank(s) or other acceptable firm(s), which can be non-limitingly referred to as an ‘underwriter’. The reserved tender advance facility is established for an aggregate value minimally equal to the principal amount of debt to be undertaken; however, interest amounts payable may also be covered by the underwriter, as the case may be. In a preferred embodiment, the underwriter can be an investment grade institution such that its rating will translate to the financial instruments to be issued. The reserved tender advance facility is available for the purposes of providing short-term credit and liquidity for the financial/debt instruments issued as ultimately secured by approved investment activities of the borrower as will be available on such account approved by the underwriter once the management and administration of finance proceeds commences by the borrower or the borrower's nominee. The reserved tender advance facility will remain on ‘standby’ until such time as a drawing of proceeds thereof is received from the trustee or administrator of the debt obligations/financial instruments.

Next, financial instruments/debt obligations are sold (2) into a suitable subscriber base or to a suitable lender. Upon issuance and subscription of the financial instruments/debt obligations, the financing proceeds are deposited (3) to such account(s) approved by the underwriter where the financing proceeds will be invested in eligible investments or commercial activities. Permitted investment or commercial activities continue (4) within approved accounts under the supervision of the underwriter. At some point following the date of subscription, an optional or mandatory tender of the financial instruments/debt obligations occurs and financial instruments/debt obligation are directed (5) by the administrator of the debt obligations/financial instruments for satisfaction of the tender. The administrator gives notice and instruction (6) to a designated remarketing agent that has been engaged to remarket the financial instruments/debt obligations in the event of a tender or other similar event to alternative subscribers prior to the tender settlement date. Within the permitted timeframe, the remarketing agent will likely successfully remarket the tendered financial instruments/debt obligations and remarketing proceeds would be applied by the administrator in satisfaction of the tender. For the purposes of illustration, however, assume the remarketing agent will have failed to timely remarket all or a portion of the tendered financial instruments/debt obligations, thus producing a shortfall of remarketing proceeds required to satisfy the tender and giving notice (7) of such shortfall to the administrator.

Under this assumption, the administrator of the debt obligations/financial instruments will submit a draw (8) against the reserved tender advance facility for an amount of reserved tender advance proceeds that, when taken together, equal an aggregate maximum amount of the remarketing proceeds shortfall. Against its receipt of a draw under the reserved tender advance facility with notice of which financial instruments/debt obligations are being tendered (which will, upon repurchase with reserved tender advance facility proceeds, be recorded as ‘pledged notes’ or ‘pledged financial instruments’ held for the direct and specific benefit of the underwriter), the underwriter may secure its position with a first lien (9) against a permitted value of eligible investments as held on such agreed account, with such lien made active upon the disbursement of the corresponding reserved tender advance amount as the basis to fully satisfy the tender.

Under this assumption, then the reserved tender advance is disbursed (10) covering the amount of the reserved tender drawing. The administrator of the debt obligations/financial instruments will disburse to the subscriber(s) (11) proceeds required to satisfy the tender. Those financial instruments/debt obligations that have been repurchased with proceeds derived from the reserved tender advance facility will be held for the benefit of the underwriter. The value of eligible investments that may secure the underwriter for the amount of the reserved tender advance correspond to the principal portion of the financial instruments/debt obligations held for the benefit of the underwriter. The remarketing agent will continue to remarket the tendered financial instruments/debt obligations, and upon the successful remarketing thereof, remarketing proceeds arising there from will be deposited (12) with the administrator.

The administrator of the debt obligations/financial instruments will onward advise (13) the remarketing proceeds to the underwriter to reimburse amounts drawn. The underwriter will then release (14) its security interest in the ‘pledged notes’ and any eligible investments held in support of the previously advanced amount. With no further encumbrance on the investments, the reserved tender advance facility returns (15) to its ‘standby’ state until such time as another reserved tender drawing is received.

The following examples are non-limiting examples of implementations of the financial process of the present invention. For the purposes of explanation and not to narrow the scope of the present invention, in certain of the following examples, a financial instrument issuance is enabled as the basis to avail certain capital by or on behalf of a qualified entity as the borrower or beneficiary of the capital and such financial instrument is credit enhanced and supported for liquidity upon permitted tender or redemption by an operation in accordance with the financial process of the present invention. For the purposes of explanation and not to narrow the scope of the present invention, in certain of the following examples the capital to be availed and coordinated with the operation in accordance with the financial process of the present invention can be derived from financial instrument or securities issuance, direct borrowing, the establishment of debt facilities, leverage facilities or equity investment. For the purposes of explanation and not to narrow the scope of the present invention, in certain of the following examples the reserved tender advance facility may sometimes be referred to with a specified descriptive financial prefix denoting the features, characteristics or applications of that particular type of reserved tender advance facility.

### EXAMPLE 1

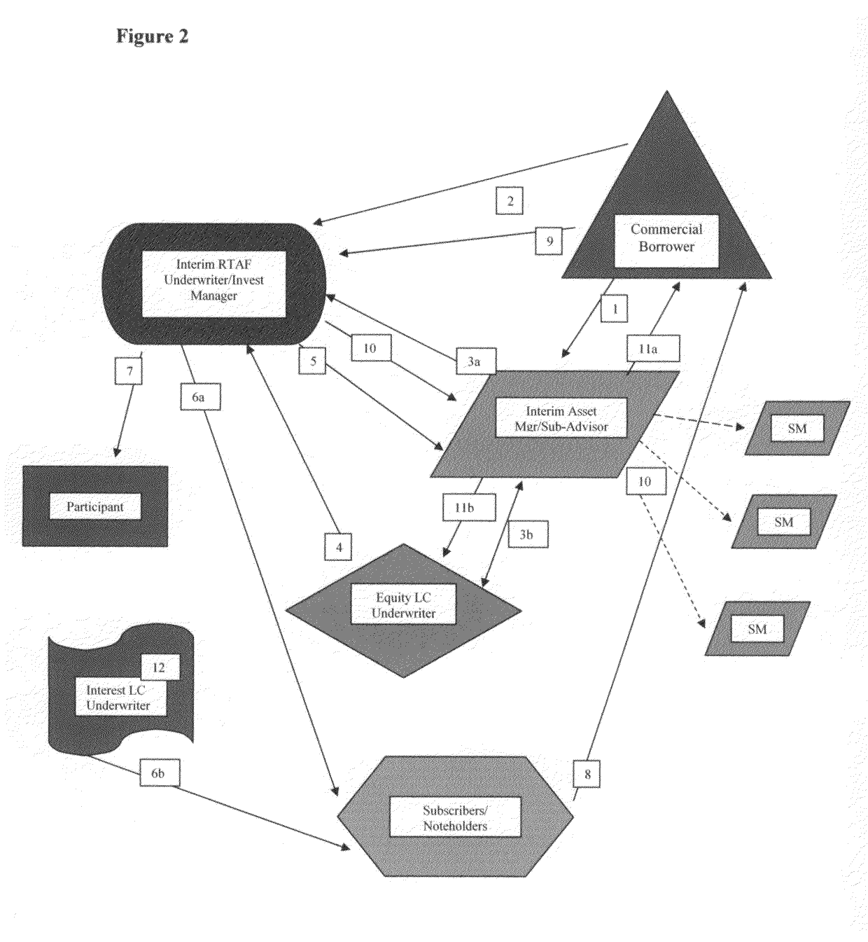

As previously referenced, a financial process in accordance with the principals of the present invention can take the form of an interim reserved tender advance facility. Referring now to FIG. 2, a methodological schematic is seen showing a use and application of an interim reserved tender advance facility. Such interim reserved tender advance facility can be used for example in support of investment operations of a hedge fund, alternative investment manager, asset manager, fund of fund, and/or other single or multi-strategy investment fund in coordination with the management of a commercial borrower's debt proceeds arising from the borrower's independently established debt capital facilities or through the sale or placement of financial instruments, debt obligations, and/or other financing instruments. This example incorporates the processes described in conjunction with FIG. 1.

Initially, a commercial operating company or project as may require access to on-going finance/credit (non-limitingly referred to as the “Commercial Borrower” in this example) elects to issue certain financial instrument/debt obligation to support its commercial operation for a certain period of time or as the basis to cover a general scope of operations/projects. For the purposes of this example and not limitation, such a Commercial Borrower could be a real estate investment firm, construction company, manufacturer, equipment leasing company, merger and acquisition firm or such other commercial credit user. The Commercial Borrower selects (1) a qualified investment manager, asset manager, hedge fund, fund of fund or other similar investment firm (non-limitingly referred to as the “Interim Asset Manager” in this example). The Interim Asset Manager is engaged to invest or manage debt capital arising from the issuance of financial instruments/debt obligations (non-limitingly referred to as the “Credit Proceeds” in this example) into certain eligible investments until such time as the Credit Proceeds are actively deployed into the Commercial Borrower's commercial operations or designated projects. The Interim Asset Manager produces yield or income from its management or investment of the Credit Proceeds in eligible investments sufficient to cover or offset accruing interest charges on the financial instruments/debt obligations.

In support of the Interim Asset Manager's performance and as the basis to provide certain liquidity for the financial instruments that support the credit enhancement of minimally the principal amount of the financial instruments/debt obligations, the Commercial Borrower engages (2) an interim reserved tender advance facility underwriter that has approved the investment strategy of the Interim Asset Manager, naming the trustee of the financial instruments/debt obligations or such other similar entity related to the administration of the capital/proceeds that may be designated (non-limitingly referred to as the “Trustee” in this example) as the authorized party to draw upon the interim reserved tender advance facility. In addition, reserved tender advance facility fees are established and draw reimbursement terms defined.

In response to the Commercial Borrower's engagement of the interim reserved tender advance facility, the Interim Asset Manager agrees either to pledge its eligible investments in favor of the interim reserved tender advance facility underwriter in support of the operation of the reserved tender advance facility or to engage the interim reserved tender advance facility underwriter as the investment supervisor of the activities of the Interim Asset Manager. For the purposes of this example, the Interim Asset Manager sub-contracts (3a) all or a portion of its interim asset management responsibilities to the interim reserved tender advance facility underwriter, naming it as the Interim Asset Manager's nominated investment manager. This can be coupled with a nomination of the Interim Asset Manager as a sub-advisor to the interim reserved tender advance facility underwriter/investment manager.

This creates a vehicle in which the investment portfolio assets need not be pledged, liened or otherwise encumbered as the basis to preserve the interim reserved tender advance facility underwriter's position on the eligible investments. This provides flexibility in the operation of the Interim Asset Manager's investment strategy. It is noteworthy that in some cases, when the Commercial Borrower is agnostic to the nature of the investment strategy or the designation of a particular Interim Asset Manager, the Commercial Borrower may elect to directly nominate the interim reserved tender advance facility underwriter as its Interim Asset Manager, thus permitting the interim reserved tender advance facility to simply designate its select investment funds, asset managers, hedge funds or fund of funds as sub-investment advisors for the benefit of the Commercial Borrower.

When the interim reserved tender advance facility underwriter is not assuming or otherwise covering first-loss or principal risk associated with the investment portfolio with its own financial resources, the Interim Asset Manager agrees (3b) to the terms of the independent issuance of an equity letter of credit by a third party entity or itself in favor of the interim reserved tender advance facility underwriter. The equity letter of credit will be issued for such agreed percentage of the principal amount of proceeds of the financial instruments/debt obligations as may be agreed with the interim reserved tender advance facility underwriter as the basis to offset up to that maximum amount of first-loss or principal risk associated with the eligible investments and risk of portfolio underperformance associated with the operation of the Interim Asset Manager's investment strategy. In exchange for the issuance of the equity letter of credit or such other methodology that may be employed to cover first-loss or principal risk associated with the eligible investments, the equity letter of credit underwriter will participate in the investment yield of the Interim Asset Manager's portfolio as if it were an equity investor therein. In the event the interim reserved tender advance facility underwriter is seeking investment exposure and participation in the investment operations of the Interim Asset Manager, there would be no equity letter of credit issued and the interim reserved tender advance facility underwriter would participate in the net yield after interest payable on the financial instruments/debt obligations plus scheduled/agreed costs in the place and stead of the equity letter of credit underwriter. For the sake of this example, the role of an equity letter of credit underwriter has been profiled.

The equity letter of credit underwriter issues (4) its letter of credit or such other instrument as may be agreed in favor of the interim reserved tender advance facility underwriter, if required. Upon the delivery of the equity letter of credit, if not before done, the interim reserved tender advance facility underwriter in its capacity as investment manager designates (5) the Interim Asset Manager as its sub-advisor that permits the Interim Asset Manager to manage Credit Proceeds directly or otherwise allocate a portion of Credit Proceeds in favor of other approved sub-managers within an interim reserved tender advance facility underwriter prescribed investment strategy/guideline.

A maximum of up to 100% liquidity of the principal amount of the financial instruments/debt obligations (which is equal to the amount of Credit Proceeds) is made available (6a) upon draw by the Trustee for the benefit of the Subscribers/Noteholders. The interim reserved tender advance facility may also agree to cover an amount of interest payable in excess of the principal amount referenced, but for the purposes of this example and further examples to follow, the reserved tender advance facility is assumed to only cover the principal portion of the financial instruments/debt obligations. As such, for the purposes of this example, an interest letter of credit underwriter issues (6b) its revolving letter of credit or similar instrument acceptable to the purchasers of the financial instruments/debt obligations or the lender of the Credit Proceeds in order to cover periodic interest payable.

Upon interim reserved tender advance facility activation, any financial participant royalties/fees are distributed (7) by the interim reserved tender advance facility underwriter from gross fees received from the Commercial Borrower for the establishment and operation of the reserved tender advance facility. Financial instruments/debt obligations are placed with qualified institutional buyers or other candidate purchasers (non-limitingly referred to as the “Subscribers/Noteholders” in this example) via a private placement or other manner of offering as administered by a placement agent or subscription underwriter within the context of the institutional capital markets, and proceeds thereof are disbursed (8) in favor of the Commercial Borrower or, alternatively, credit facilities are otherwise activated with a suitable lender that will lend Credit Proceeds. For the purposes of example, the placement of certain financial instruments is profiled rather than the granting of specific credit from a given lender or loan syndication, although such a process could also be employed with reference to the operation of a reserved tender advance facility. Thereafter, Credit Proceeds are credited (9) to a custodial account for use or application to the Interim Asset Manager's designated eligible investments as approved by the interim reserved tender advance facility underwriter.

As and when applicable, for example in the case of an Interim Asset Manager being a fund of funds or fund manager that utilizes third party independent investment managers as part of its core investment strategy, Credit Proceeds are allocated and disbursed (10) from the custodial account in favor of the approved Interim Asset Manager's nominated and interim reserved tender advance facility underwriter-approved sub-managers. The Interim Asset Manager commences its investment management operations and periodic yield distributions are paid (11a) to or on behalf of the Commercial Borrower to cover agreed interest payable. Periodic investment participation over agreed operating costs is distributed (11b) to the equity letter of credit underwriter per the terms of its agreement with the Interim Asset Manager. The interest letter of credit or such other payment instrument for interest that may be employed is thereafter reimbursed (12) from yield distributions, interest reserves or otherwise for an amount equal to periodic interest drawn by the Trustee for the benefit of the Subscribers/Noteholders or Credit Proceeds lender.

### EXAMPLE 2

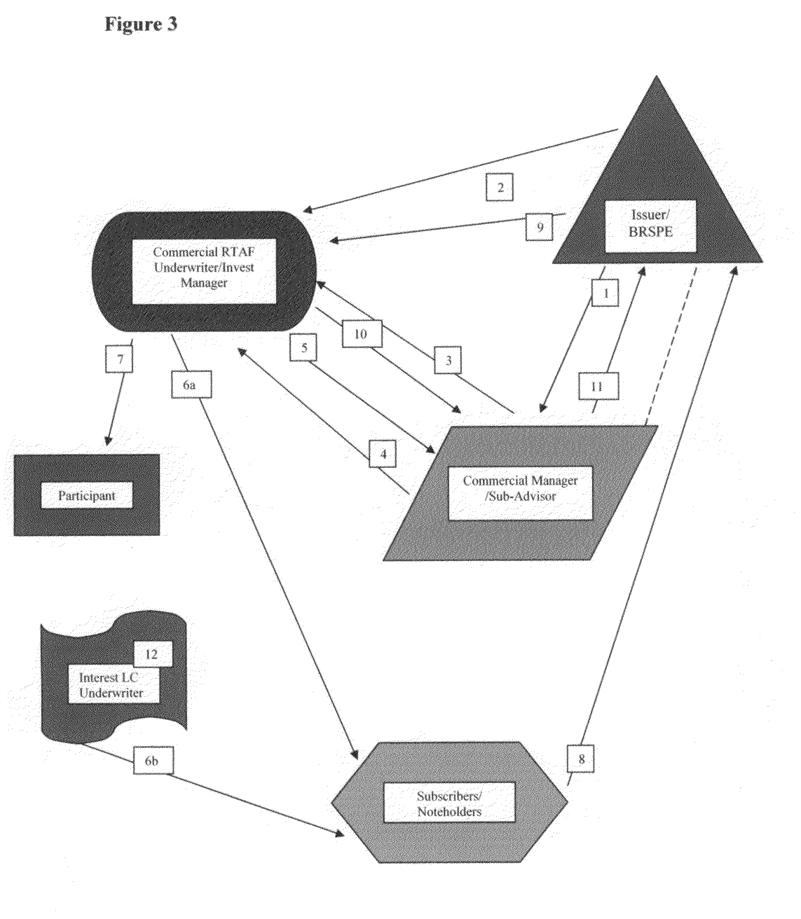

As previously referenced, a financial process in accordance with the principals of the present invention can take the form of a commercial reserved tender advance facility. Referring now to FIG. 3, a methodological schematic is seen showing the use and application of a commercial reserved tender advance facility in support of the commercial operations of a borrower. This example calls for the active management and use of warehousing, revolving and/or transactionally-oriented credit facilities as initially financed or funded through the borrower's independently established debt capital facilities or through the sale or placement of financial instruments, debt obligations, and/or other financing instruments. This example likewise incorporates the processes in conjunction with FIG. 1.

Initially, a commercial operating company which core commercial operation requires consistent access to a revolving credit line, warehouse line or other similar credit facility with revolving or renewable credit for extended terms (non-limitingly referred to as the “Commercial Manager” in this example) elects to establish such credit facilities through the raising of initial funding via the issuance of certain financial instruments/debt obligations. For the purposes of this example and not limitation, such a Commercial Manager could be a commercial real estate lender, mortgage banker, trade finance company, specialty finance company, commodity trading firm or such other similar commercial credit user. For the purposes of example and in order to illustrate how certain bankruptcy remote attributes may be employed as the basis to better preserve the position of the qualified institutional buyers or other candidate purchasers (non-limitingly referred to as the “Subscriber/Noteholders” in this example) as the source of credit proceeds, the Commercial Manager will establish a (bankruptcy-remote) special purpose entity (non-limitingly referred to as the “Issuer” in this example) for the purposes of issuance of the financial instruments/debt obligations to raise credit proceeds in support of its commercial operation for a certain period of time or as the basis to cover a general scope of operations/projects. The Issuer engages (1) the Commercial Manager to invest or manage the credit proceeds in certain approved commercial investments.

In support of the Commercial Manager's performance and as the basis to provide certain liquidity for the financial instruments/debt obligations and support the credit enhancement of minimally the principal amount of the financial instruments/debt obligations, the Issuer engages (2) a commercial reserved tender advance facility underwriter that has approved the commercial underwriting strategy of the Commercial Manager, naming the trustee of the financial instruments/debt obligations or such other similar entity related to the administration of the capital/proceeds that may be designated (non-limitingly referred to as the “Trustee” in this example) as the authorized party to draw upon the commercial reserved tender advance facility. In addition, reserved tender advance facility fees are established and reimbursement terms defined. In response to the Issuer's engagement of the commercial reserved tender advance facility, the Commercial Manager agrees (3) either to pledge its commercial investments in favor of the commercial reserved tender advance facility underwriter in support of the operation of the reserved tender advance facility or to engage the commercial reserved tender advance facility underwriter as the investment supervisor of the activities of the Commercial Manager. For the purposes of this example, the Commercial Manager sub-contracts all or a portion of its commercial management responsibilities to the commercial reserved tender advance facility underwriter, naming it as the Commercial Manager's nominated investment manager. This is coupled with a nomination of the Commercial Manager as a sub-advisor to the commercial reserved tender advance facility underwriter/investment manger and the commercial underwriting guidelines of the Commercial Manager that are thereafter approved by the commercial reserved tender advance facility underwriter as investment manager.

This creates a vehicle in which the commercial assets generated or otherwise manifest from the Commercial Manager's approved commercial activities need not be pledged, liened or otherwise encumbered as the basis to preserve the commercial reserved tender advance facility underwriter's position on the commercial investments. This provides flexibility in the revolving nature of the operation of the Commercial Manager's commercial underwriting strategy, which calls for a consistent and efficient means to substitute investments or custodial account holdings without being hindered by the administration of ‘collateral substitutions’, lien holdings, charges, and investment specific security interests. Additionally, at this step, the Commercial Manager will normally agree to the terms of its or a nominee's issuance of an equity letter of credit in favor of the commercial reserved tender advance facility underwriter for such value as may be agreed with the commercial reserved tender advance facility underwriter representing transaction equity. The equity letter of credit is issued as the basis to offset principal risk associated with the commercial underwriting exposure and risk of portfolio underperformance associated with the operation of the Commercial Manager's portfolio. In the event the commercial reserved tender advance facility underwriter is seeking investment exposure and participation in the operations of the Commercial Manager, there would be no or a reduced equity letter of credit issued and the commercial reserved tender advance facility underwriter would participate in a portion of the net yield after interest plus scheduled/agreed costs. For the sake of this example, the Commercial Manager is proposed for issuance of an equity letter of credit underwriter in support of its commercial underwriting and operations.

The equity letter of credit is issued (4) and thereafter increased as commercial transaction volume and capital absorption increases in the Commercial Manager's investment portfolio. Upon the delivery of the equity letter of credit, if not before done, the commercial reserved tender advance facility underwriter in its capacity as investment manager designates (5) the Commercial Manager as its sub-advisor and permits the Commercial Manager to allocate credit proceeds and to underwrite or engage in commercial transactions within a prescribed investment/commercial underwriting guideline.

A maximum of up to 100% liquidity of the principal amount of the financial instruments/debt obligations (which is equal to the credit proceeds) is made available (6a) upon draw by the Trustee on behalf of the Subscribers/Noteholders. The commercial reserved tender advance facility may also agree to cover an amount of interest payable in excess of the principal amount referenced, but for the purposes of this example, an interest letter of credit underwriter issues (6b) its revolving letter of credit or similar instrument acceptable to the Subscriber/Noteholders to cover periodic agreed interest payable.

Upon commercial reserved tender advance facility activation, any financial participant royalties/fees are distributed (7) by the commercial reserved tender advance facility underwriter from gross fees received from the Issuer for the establishment and operation of the reserved tender advance facility. Against the principal and interest protection referenced above, the financial instruments/debt obligations are placed with qualified Subscribers/Noteholders and proceeds are availed/disbursed (8) for the benefit of the Issuer (a bankruptcy-remote special purpose entity). For the purposes of illustration, the placement of certain financial instruments/debt obligations is profiled rather than the granting of specific credit from a given lender or loan syndication, although such a process could also be employed with reference to the operation of a reserved tender advance facility.

Credit proceeds are credited (9) to a custodial account approved and designated by the commercial reserved tender advance facility underwriter for use by the Commercial Manager. Credit proceeds are thereafter actively applied (10) to the intended and approved commercial operations of the Commercial Manager pursuant to commercial underwriting guideline. In this context, the functionality of the commercial underwriting guideline will call for a specific type or consistent format of commercial transaction to be engaged, and the Commercial Manager can thereafter substitute alternative transactions and commercial assets/investments for the existing commercial transactions held within the portfolio, thereby establishing the operation of the commercial reserved tender advance facility in such a way as to enable the necessarily revolving dynamic of the commercial underwriting strategy required by the Commercial Manager's business model.

The Commercial Manager commences its commercial underwriting operations and periodic yield distributions are paid (11) to the issuer to cover interest payable. The issuer reimburses (12) the interest letter of credit or such other payment instrument for interest that may be employed for an amount equal to periodic interest drawn by Trustee for the benefit of the Subscribers/Noteholders or credit proceeds lender.

### EXAMPLE 3

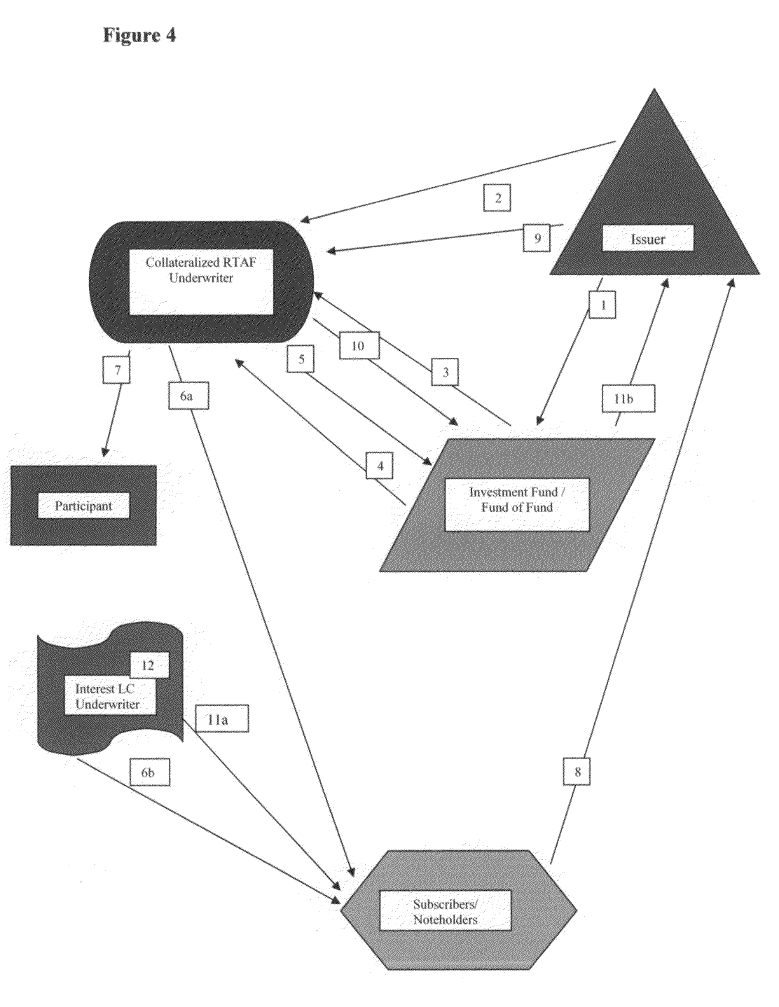

As previously referenced, a financial process in accordance with the principals of the present invention can take the form of a collateralized reserved tender advance facility. Referring now to FIG. 4, a methodological schematic is seen showing the use and application of a collateralized reserved tender advance facility. This example acts as an alternative to conventional leverage/credit facilities in support of the investment operations of a hedge fund, alternative investment manager, asset manager, fund of fund and/or other single or multi-strategy investment fund as initially financed or funded through the hedge fund's, alternative investment manager's, asset manager's, fund of fund's and/or other single or multi-strategy investment fund's issuance of financial instruments, debt obligations and/or other financing instruments. This example likewise incorporates the processes in conjunction with FIG. 1.

While not so limited hereunder, in a preferred embodiment the collateralized reserved tender advance facility is best-suited for applications in which a debt instrument issuer is or is otherwise directly affiliated with the investment fund, fund of funds or asset manager that will manage the debt proceeds. In many instances, the collateralized reserved tender advance facility in its application behaves as and may be used as a surrogate for the issuance of a conventional collateralized fund obligation.

Initially, an investment manager, hedge fund, fund of funds, asset manager or other similar investment management company or fund (non-limitingly referred to as the “Fund” in this example) requires leverage for its available equity investment proceeds. In lieu of seeking a conventional leverage facility, the Fund elects to establish certain credit facilities to complement its available equity via the issuance of certain financial instruments/debt obligations.

For the purposes of example and in order to illustrate how certain bankruptcy remote attributes may be employed as the basis to better preserve the position of the lender (non-limitingly referred to as the “Subscriber/Noteholders” in this example) as the source of credit proceeds, the Fund will establish a (bankruptcy-remote) special purpose entity (non-limitingly referred to as the “Issuer” in this example) for the purposes of issuance of the financial instruments/debt obligations to raise credit proceeds in support of its investment or fund operations. The Issuer engages (1) the Fund to invest or manage the credit proceeds in certain approved investment strategies.

In support of the Fund's performance and as the basis to provide certain liquidity for the financial instruments/debt obligations that supports the credit enhancement of minimally the principal amount of the financial instruments/debt obligations, the Issuer engages (2) a collateralized reserved tender advance facility underwriter that has approved the investment strategy of the Fund, naming the trustee of the financial instruments/debt obligations or such other similar entity related to the administration of capital/proceeds that may be designated (non-limitingly referred to as the “Trustee” in this example) as the authorized party to draw upon the collateralized reserved tender advance facility. In addition, reserved tender advance facility fees are established and reimbursement terms defined.

In response to the Issuer's engagement of the collateralized reserved tender advance facility underwriter, the Fund agrees (3) either to pledge its investments in favor of the collateralized reserved tender advance facility underwriter in support of the operation of the reserved tender advance facility or to engage the collateralized reserved tender advance facility underwriter as the investment manager/supervisor of the activities of the Fund. Although the collateralized reserved tender advance facility underwriter and Fund may choose to sub-contract or nominate a sub-advisor as illustrated in prior examples, for the purposes of illustration of an alternative methodology, in this example, the Fund allows the creation of a pledge or lien on the investments and the agreed portion of equity to be provided by the Fund to the collateralized reserved tender advance facility underwriter (whether in the form of an equity letter of credit, cash or other form of collateral acceptable to the collateralized reserved tender advance facility underwriter) in coordination with the establishment of an approved investment strategy and scope for the Fund's operations, inclusive of the identification for engagement of other approved funds or asset managers as sub-managers to the Fund. This can sometimes better enable the operation of the Fund as a fund of funds in which shares of approved sub-managers are held by the Fund and pledged to the collateralized reserved tender advance facility underwriter. Additionally, at this point, the Fund is able to incorporate its or a nominee's issuance of an equity letter of credit or such other pledge of agreed equity in favor of the collateralized reserved tender advance facility underwriter as the basis to offset principal risk or fist-loss risk associated with the devaluation of the investments and/or the risk of portfolio underperformance associated with the operation of the investments.

The equity letter of credit is issued (4) having a face value sufficient to cover the agreed percentage of first-loss risk associated with the operation of the investment strategy as assessed and agreed with the collateralized reserved tender advance facility underwriter. The collateralized reserved tender advance facility creates a pledge or lien on the investments and approves (5) all proposed sub-managers to be engaged by the Fund, if any.

A maximum of up to 100% liquidity of the principal amount of financial instruments/debt obligations (although a portion of interest may be agreed to be covered as well) is made available (6a) upon draw by the Trustee on behalf of the Subscribers/Noteholders. The interest letter of credit underwriter issues (6b) its revolving letter of credit or similar instrument acceptable to the purchasers of the financial instruments/debt obligations or the lender of the credit proceeds in order to cover covering periodic interest payable. Upon collateralized reserved tender advance facility activation, financial participant royalties/fees, if any, are distributed (7) by the collateralized reserved tender advance facility underwriter from gross fees received from the Issuer in consideration of the operation and establishment of the collateralized reserved tender advance facility.

Against the principal and interest protection referenced above, the financial instruments/debt obligations are placed with qualified institutional buyers or other candidate purchasers or credit facilities are otherwise activated with the Subscribers/Noteholders and proceeds are availed/disbursed (8) for the benefit of the Issuer. For the purposes of illustration, the placement of certain financial instruments/debt obligations is profiled rather than the granting of specific credit from a given lender or loan syndication, although such a process could also be employed with reference to the operation of a reserved tender advance facility. Thereafter, credit proceeds are credited to a custodial account.

Credit proceeds are transferred to or otherwise approved (9) for use or application to the Funds' designated investments by the collateralized reserved tender advance facility underwriter. As and when applicable, for example in the case of an Fund being a fund of funds or fund manager that utilizes third party independent investment managers as part of its core investment strategy, credit proceeds are allocated and disbursed (10) with the collateralized reserved tender advance facility underwriter's approval from the custodial account in favor of approved sub-managers nominated for use by the Fund.

The Fund commences its investment operations and periodic yield distributions are paid out (11a) by interest letter of credit issuer to cover interest payable; periodic investment participation over operating agreed costs is distributed (11b) to cover the reimbursement of interest and the payment of agreed fees. The issuer reimburses (12) the interest letter of credit or such other payment instrument for interest that may be employed for an amount equal to periodic interest drawn by Trustee for the benefit of the Subscribers/Noteholders or credit proceeds lender.

### EXAMPLE 4

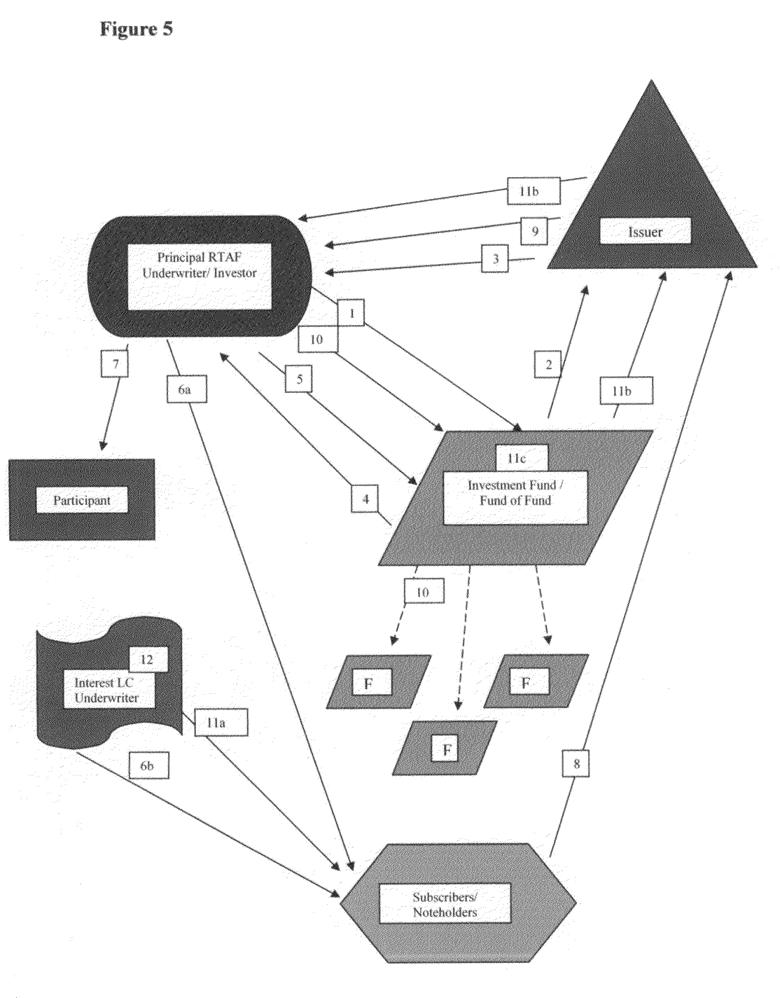

As previously referenced, a financial process in accordance with the principals of the present invention can take the form of a principal reserved tender advance facility. Referring now to FIG. 5, a methodological schematic showing the use and application of a principal reserved tender advance facility. This example acts as a cash-alternative investment vehicle designed to provide investment exposure to and participation in the investment operations of a hedge fund, alternative investment manager, asset manager, fund of fund, other single or multi-strategy investment fund and/or commercial investment manager via the coordination of the hedge fund's, alternative investment manager's, asset manager's, fund of fund's, other single or multi-strategy investment fund's, and/or commercial investment manager's issuance of financial instruments, debt obligations and/or other financing instruments. This example likewise incorporates the processes in conjunction with FIG. 1.

Initially, an investment manager, hedge fund, fund of funds, asset manager or other similar investment management company or fund (non-limitingly referred to as the “Fund” in this example) has been identified as a desirable investment opportunity by an investor. The investor is of a certain minimum quality and credit profile to be a suitable reserved tender advance facility underwriter, and as an added characteristic in this example, although not required, the investor is also subject to certain RBC reserve assessments in relation to the nature of the investments the investor undertakes. Such an investor may be for example an insurance carrier or other financial institution. The investor agrees with the Fund that it will be willing to act as a principal reserved tender advance facility underwriter, bearing the first-loss and principal risk associated with the Fund's operation of its investment strategy; provided, however that the Fund is willing to issue certain financial instruments via an affiliated entity. The investor, in its capacity as principal reserved tender advance facility underwriter, will support the financial instruments with certain credit enhancement and liquidity facilities in consideration of the principal reserved tender advance facility underwriter/investor's receipt of certain consideration from the Fund in the form of participation in Fund yield in excess of the interest costs and other annual charges and fees associated with the operation of the financial instruments.

The Fund will establish (2) a (bankruptcy-remote) special purpose entity (non-limitingly referred to as the “Issuer” in this example) for the purposes of issuance of the financial instruments to raise capital or credit proceeds and with which the operation of the principal reserved tender advance facility will coordinate. The Fund will be designated to invest or manage the capital or credit proceeds in certain approved investment strategies.

In support of the Fund's performance and as the basis to provide certain liquidity for the financial instruments that supports the credit enhancement of minimally the principal amount of the financial instruments, the Issuer engages (3) the principal reserved tender advance facility underwriter/investor, naming the trustee of the financial instruments or such other similar entity related to the administration of the capital/proceeds that may be designated (non-limitingly referred to as the “Trustee” in this example) as the authorized party to draw upon the principal reserved tender advance facility. In addition, reserved tender advance facility fees are established and reimbursement terms defined.

In response to the Issuer's engagement of the principal reserved tender advance facility underwriter, the Fund likely agrees to pledge (4) its investments in favor of the principal reserved tender advance facility underwriter in further support of the operation of the reserved tender advance facility. Note that the principal reserved tender advance facility underwriter could alternatively be engaged as the investment manager/supervisor of the activities of the Fund, but this is not illustrated here. As the basis to enable this pledge structure, the Fund creates a pledge or lien on the investments, and establishes the permitted nature of the Fund's investments, inclusive of the identification for engagement of other approved funds or asset managers as sub-managers to the Fund. This can sometimes better enable the operation of the Fund as a fund of funds in which shares of approved sub-managers are held by the Fund and pledged to the principal reserved tender advance facility underwriter.

The principal reserved tender advance facility creates a pledge or lien on the investments and approves (5) all proposed sub-managers to be engaged by the Fund, if any. A maximum of up to 100% liquidity of the principal amount of financial instruments (although a portion of interest may be agreed to be covered as well) is made available (6a) upon draw by the Trustee on behalf of the Subscribers/Noteholders The interest letter of credit underwriter issues (6b) its revolving letter of credit or similar instrument acceptable to the purchasers of the financial instruments/debt obligations or the lender of the credit proceeds in order to cover covering periodic interest payable. The interest letter of credit underwriter could be the same institution as the principal reserved tender advance facility underwriter. Upon principal reserved tender advance facility activation, principal reserved tender advance facility underwriter/investor remits (7) agreed fees and charges to assorted financial participant royalties/fees, in consideration of its ability to utilize and employee the principal reserved tender advance facility mechanism as an investment process.

Against the principal and interest protection referenced above, the financial instruments are placed (8) with qualified institutional buyers or other candidate purchasers or credit facilities are otherwise activated with a suitable lender that will lend capital or credit proceeds (non-limitingly referred to as the “Subscribers/Noteholders” in this example). For the purposes of illustration and in a preferred embodiment, the placement of certain financial instruments is profiled as the source of capital to coordinate with the operation of a principal reserved tender advance facility, rather than the establishment of specific credit from a given lender or loan syndication, although such a process could also be employed with reference to the operation of a principal reserved tender advance facility. Thereafter, credit proceeds are credited to a custodial account.

Credit proceeds are transferred to or otherwise approved (9) for use or application to the Funds' designated investments by the principal reserved tender advance facility underwriter. As and when applicable, for example in the case of a Fund being a fund of funds or fund manager that utilizes third party independent investment managers as part of its core investment strategy, credit proceeds are allocated and disbursed (10) with the principal reserved tender advance facility underwriter's approval from the custodial account in favor of approved sub-managers nominated for use by the Fund.

The Fund commences its investment operations and periodic yield distributions are paid out (11a) by interest letter of credit issuer to cover interest payable; periodic investment participation over operating agreed costs is distributed (11b) to cover the investment yield participation due to the principal reserved tender advance facility underwriter/investor, the reimbursement of interest, and the payment of agreed fees; and (11c) management fees are accrued for credit to Fund. The issuer reimburses (12) the interest letter of credit or such other payment instrument for interest that may be employed for an amount equal to periodic interest drawn by the Trustee for the benefit of the Subscribers/Noteholders.

Referring Tables 1 and 2, below, a theoretical mathematical profile is seen comparing the potential economic impact of the application of the principles of the present invention on an investor that is subject to RBC reserve requirement and corresponding calculations with reference to its investment portfolio operation in a conventional cash-based investment versus an reserved tender advance facility-based cash-alternative investment function.

TABLE 1
Conventional Investment in Hedge Fund or Alternative Investment
Portfolio

| Amount Invested | US$100,000,000 |
|---|---|
| Form of Investment | Cash |
| Risk Based Capital Category | 9 |
| RBC Reserve Assessed based upon Category | 30% |
| Minimum Reserve Amount [(Amount Invested) × | US$30,000,000 |
| 30%] | |
| Amount Reserve to support AA rating [2 × | US$60,000,000 |
| (MinResAmt)] | |
| Non-cash/balance sheet allocation | US$ n/a |
| Remarketing Liquidity (allocated, not reserved) | US$ n/a |
| Min Gross Cash Allocated (supporting Investment) | US$130,000,000 |
| Max Gross Cash Allocated (support AA rating) | US$160,000,000 |
| Annual Gross Yield on Amount Invested | 10% |
| Gross Return (in $) on Amount Invested | US$10,000,000 |
| Cost of Capital/Hurdle [(Mgr fees)] | 1.0% |
| Annual Return after CoC/Hurdle | 9.0% |
| Mgr Yield Participation [(20%) × (Ann Gross Yield)] | 2.0% |
| Net Return on Amount Invested | 7.0% |
| Net Return (in $) on Amount Invested | US$7,000,000 |
| IRR on Min Gross Cash Allocated | 5.4% |
| Net Return on Amount Invested | 7.0% |
| IRR on Max Gross Cash Allocated | 4.37% |

Table 1 defines the characteristics of a conventional investment framework for a one-year period involving a cash investment in a hedge fund or alternative investment fund by a firm that is subject to RBC reserve assessments. For the purposes of illustration, this is profiled as a US$100,000,000 principal investment. The anticipated RBC rating of this type of investment would be an estimated category 9 which would translate a RBC reserve percentage of 30% of the principal amount of the investment amount, or a US$30,000,000 minimum reserve amount with a US$60,000,000 reserve amount if a “AA” rating is desired by the investor under conventions of rating this type of institution. Under this scenario, the required capital allocations to enable a US$100,000,000 investment is minimally US$130,000,000 (the amount to be invested plus capital from operations required to cover minimum 30% reserve requirements) and a maximum of US$160,000,000 (the amount to be invested plus capital from operations required to cover double the minimum calculated reserve requirements) in order to better meet a target “AA” credit rating assignment resultant from a review of the SVRA balance.

Then, assuming an annual rate of return on the invested capital of 10%, a US$10,000,000 gross yield is generated. From this, an estimated 3% manager fee and participation amount is subtracted ((m)+(o)), leaving a net annual return in investment of 7% or US$7,000,000. Using these figures, an estimated internal rate of return to the investor ranging from between 4.37% and 5.4% can be anticipated by dividing the net annual rate of return by the maximum and minimum amounts of required capital to enable the investment, respectively.

TABLE 2
Investment in Hedge Fund or Alternative Investment Portfolio using
Reserve Tender Advance Facility

| Amount Invested | US$100,000,000 |
|---|---|
| Form of Investment | reserved tender |
| | advance facility |
| Risk Based Capital Category | 3 |
| RBC Reserve Assessed based upon Category | 4% |
| Minimum Reserve Amount [(Amount Invested) × 4%] | US$4,000,000 |
| Amount Reserve to support AA rating [2 × | US$8,000,000 |
| (MinResAmt)] | |
| Non-cash/balance sheet allocation | US$100,000,000 |
| Remarketing Liquidity (contingent allocation, | US$10,000,000 |
| not reserved) | |
| Min Gross Cash Allocated (supporting Investment) | US$14,000,000 |
| Max Gross Cash Allocated (support AA rating) | US$18,000,000 |
| Annual Gross Yield on Amount Invested | 10% |
| Gross Return (in$) on Amount Invested | US$10,000,000 |
| Cost of Capital/Hurdle [LIBOR + (15 bps) + | 6.5% |
| (1% Mgr fee)] | |
| Annual Return after CoC/Hurdle | 3.5% |
| Mgr Participation [(40%) × (Ann Ret after | 1.4% |
| CoC/Hurdle)] | |
| Net Return on amount invested | 2.1% |
| Net Return on amount invested (in $) | US$2,100,000 |
| IRR on Min Gross Cash Allocated | 15% |
| IRR on Max Gross Cash Allocated | 11.66% |

By comparison, in examining the data in Table 2, the characteristics of a cash-alternative investment framework for a one year period involving a reserved tender advance facility of the present invention is seen. Again, this is profiled as a US$100,000,000 principal investment in a hedge fund or alternative investment fund by a firm that is subject to RBC reserve assessments. The anticipated RBC rating of this type of investment as adapted for the utilization of the reserved tender advance facility of the present invention would be anticipated at an average risk rating of category 3 which would translate to an estimated RBC reserve percentage of 4% of the principal amount of the investment amount, or a US$4,000,000 (e) minimum reserve amount with a US$8,000,000 reserve amount if a “AA” rating is desired by the investor under conventions of rating this type of institution. Under this scenario, the required capital allocations to enable a non-cash-based US$100,000,000 is equal to the sum of an estimated remarketing liquidity allocation of 10% of the principal value of the investment or US$10,000,000 which is not required under a conventional cash-based investment as demonstrated in Table 1 and the minimum reserve amount or the maximum reserve amount which is minimally US$14,000,000 and a maximum of US$18,000,000 in order to better meet a target “AA” credit rating assignment resultant from a review of the SVRA balance.

Then, assuming an annual rate of return on the invested capital of 10% (k), a US$10,000,000 gross yield is generated. From this, an estimated 6.5% cost of capital which, for the purposes of illustration, includes an estimated 1.0% annual manager fee plus an estimated interest rate calculated the principal amount of capital (the invested amount) equal to 30-day LIBOR plus 15 basis points covering the annual cost of the debt capital, credit facilities or financial instruments that are required to raise and coordinate capital opposite the operation of a reserved tender advance facility, is subtracted leaving an annual return after cost of capital/interest hurdle of 3.5%. For the purposes of comparison, also assume the subtraction of manager participation equal to a proposed 40% of the annual return after cost of capital/interest hurdle (although an alternative manager participation may be agreed upon) or 1.4% leaving a net annual return on the amount invested of 2.1% or US$2,100,000. Using these figures, an estimated internal rate of return to the investor ranging from between 11.66% and 15% can be anticipated by dividing the net annual rate of return by the maximum and minimum amounts of required capital to enable the investment, respectively.

It is, however, important to note and recognize that, because the debt capital or credit facilities that are established to coordinate with the operation of the reserved tender advance facility as profiled under the illustration in Table 2 have certain one-time costs of establishment which can be estimated at between 70 basis points to 150 basis points of the principal amount of proceeds raised, dependent upon the number or years in the total investment term—which may range from 1-25 years at the discretion of the investor—the internal rate of return under the Table 2 illustration using the reserved tender advance facility of the present invention could be impacted by a an annual decrease equal to the amortized cost of credit establishment over the actual investment term. This adjustment is not illustrated in these comparative tables, but should be considered as a factor in comparison.

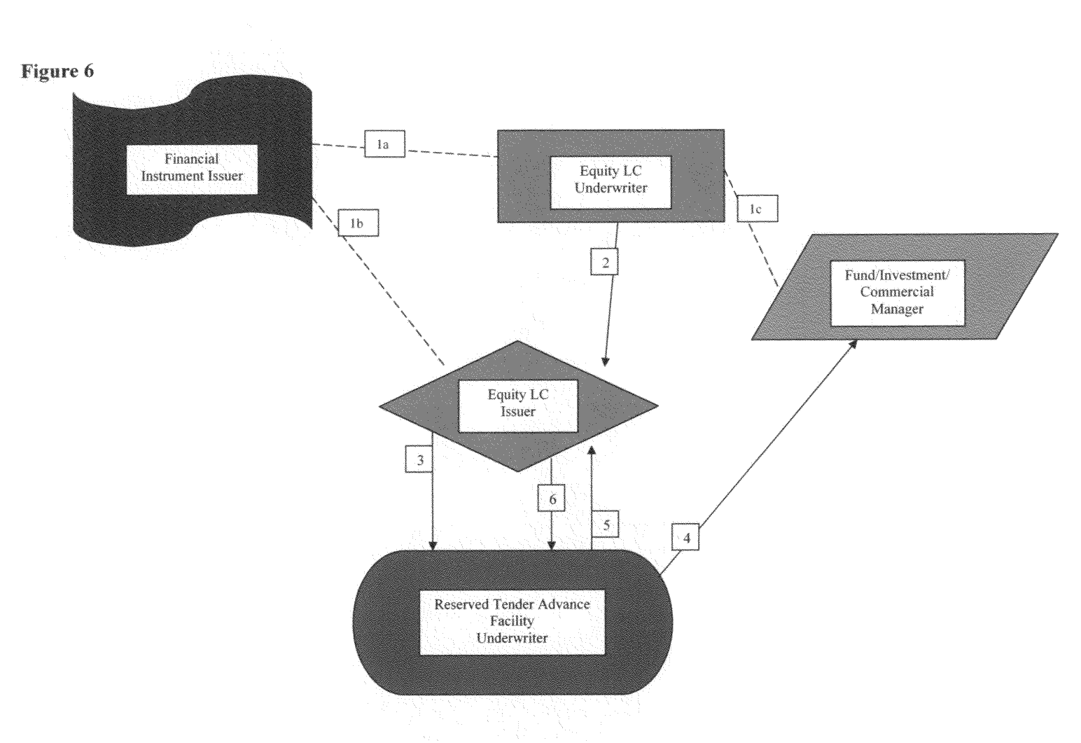

As seen in the above Examples, an equity letter of credit can be utilized as a means of defraying or otherwise offsetting first-loss risk associated with the operation of the reserved tender advance facility. Referring now to FIG. 6, a methodological schematic is seen showing the operations and commercial motivations related to the issuance and use of an equity letter of credit. As the basis to cause the issuance of an equity letter of credit in favor of the reserved tender advance facility underwriter, a variety of potential commercial factors may be present that underlie such issuance, dependent on the nature of the reserved tender advance facility; that is, whether it is for example an interim reserved tender advance facility, commercial reserved tender advance facility, or collateralized reserved tender advance facility. FIG. 6 references three possible alliances that can serve as the basis of enabling the issuance of the equity letter of credit.

The issuer of the financial instrument being credit enhanced by the reserved tender advance facility may be raising (1a) financing or funds in support of a commercial operation (as when an interim asset manager may be employed in an interim reserved tender advance facility structure) and have a direct commercial alliance with an entity possessing sufficient assets or financial strength to provide collateral to support the issuance of the equity letter of credit by a third party bank or financial institution with a primary view to supporting the commercial operation of the issuer of the financial instrument. Also in the case of an intended application of financing or capital to a commercial operation, the issuer of the financial instrument may have a relationship (1b) with a bank or other financial institution which would make a suitable equity letter of credit issuer, and that equity letter of credit issuer may extend credit directly to the issuer of the financial instrument in the form of the equity letter of credit in exchange for an issuance fee and acceptable commercial collateral either derived from the current assets of the commercial operation or tied to the enhanced commercial operations of the issuer of the financial instrument once financial instrument proceeds or credit are available for commercial use. The fund/manager may have an equity letter of credit underwriter possessing (1c) sufficient assets or financial strength to provide collateral to support the issuance of the equity letter of credit by a third party bank or financial institution with a primary view to participating in the investment yield of the fund/manager. Or the option exists that the issuer of the financial instrument, fund or manager possesses sufficient strength to support the issuance of an equity letter of credit by a bank or other financial institutions acceptable to the reserved tender advance facility underwriter.

In any event, regardless of the underpinning nature of collateral or involved parties, the necessary financial support or security interest is granted (2) by the equity letter of credit underwriter (if different from the equity letter of credit issuer) to enable the equity letter of credit issuer's delivery of an operative equity letter of credit to the name reserved tender advance facility underwriter. The equity letter of credit issuer issues and delivers (3) to the reserved tender advance facility underwriter an equity letter of credit for 25% of the principal amount of notes or other financial instruments (or such other amount deemed acceptable to the reserved tender advance facility underwriter) being credit enhanced by the operation of the reserved tender advance facility.

The reserved tender advance facility underwriter activates the reserved tender advance facility and consents (4) to the commencement of investment, commercial management or such other fund-related operations prescribed by the fund/manager against reserved tender advance facility underwriter's receipt of the equity letter of credit to cover first-losses associated with such management operations. From time-to-time during the duration of the operation of the reserved tender advance facility, the operations of the fund/manager may either cause the fund to under-perform, thus creating a drag upon the principal amount of funds under management, bringing the net asset value down below its original amount (100% principal value of notes or other financial instruments outstanding from which the proceeds have been derived), or cause a depletion or depreciation of the net asset value of proceeds under management. Upon the crystallization or realization of such loss or otherwise as may be agreed as the basis to draw all or a portion of the equity letter of credit, the reserved tender advance facility underwriter will draw (5) upon the equity letter of credit pursuant to its terms and conditions, as the basis to directly offset for any realized or agreed loss on the net asset value.

The equity letter of credit will remit (6) payment pursuant to the terms and conditions of the letter of credit in the amount compliantly drawn by the reserved tender advance facility underwriter, and the underwriter will apply such proceeds of draw to the balance of assets under management as the basis to restore it to its original value (100% principal value of notes or other financial instruments outstanding from which the proceeds have been derived).

While the invention has been described with specific embodiments, other alternatives, modifications and variations will be apparent to those skilled in the art. Accordingly, it will be intended to include all such alternatives, modifications and variations set forth within the spirit and scope of the appended claims.

1. A financial process enabling an amount of financing instruments to be credit enhanced comprising:
establishing a facility with at least one firm for an aggregate value minimally equal to the principal amount of debt to be undertaken;
maintaining the facility on standby without requiring the securing of an interest against a source until such time as a drawing made there under is received;
selling financing instruments resultant from the credit enhancement afforded by the facility;
depositing proceeds from the financing instruments in at least one account from which the proceeds can be invested;
receiving a tender of the financing instruments and directing the remarketing of the financing instruments in support of the satisfaction of the tender;
remarketing the financing instruments for repurchase prior to the tender settlement date; and
if the remarketing fails prior to the tender settlement date, thus producing a shortfall of remarketing proceeds required to satisfy the tender:
submitting a draw against the facility for an amount of proceeds that equals the remarketing proceeds shortfall;
having an option of securing an interest against a source selected from the group comprising the financing instruments, the eligible investments, and both, with such security interest made active upon the disbursement of the corresponding reserved tender advance amount as the basis to satisfy the tender;
disbursing proceeds required to satisfy the tender,
holding those financing instruments that have been repurchased with proceeds derived from the facility for the benefit of the facility underwriter;
applying the remarketing proceeds to reimburse amounts drawn; and
releasing the security interest held in support of the previously advanced amount;
whereby short-term credit and liquidity are provided for the financing instruments.

2. The financial process of claim 1 further including selling financing instruments selected from the group comprising financial instruments, debt obligations, credit facilities, and combinations thereof.

3. The financial process of claim 1 further including establishing a reserved tender advance facility.

4. The financial process of claim 3 further including establishing an interim reserved tender advance facility.

5. The financial process of claim 3 further including establishing a commercial reserved tender advance facility.

6. The financial process of claim 3 further including establishing a collateralized reserved tender advance facility.

7. The financial process of claim 3 further including establishing a principal reserved tender advance facility.

8. The financial process of claim 1 further including selecting the facility from the group comprising commercial borrowers, investment funds, hedge funds, lenders, investment banks, and combinations thereof.

9. The financial process of claim 1 further including overlaying the facility into an investor that is subjected to RBC reserve requirements related to its investment portfolio.

10. The financial process of claim 1 further including the facility acting in direct association with a short-term asset management market.

11. The financial process of claim 1 further including the facility acting in support of the operation of a revolving commercial credit function.

12. The financial process of claim 1 further including the facility acting in support of operation of a warehoused credit facility.

13. The financial process of claim 1 further including the facility acting as a surrogate to asset management functionality.

14. The financial process of claim 13 further including the reserved tender advance facility acting as a surrogate to investment leverage functionality.

15. The financial process of claim 1 further including the facility acting as a surrogate to fund functionality.

16. The financial process of claim 1 further including the facility acting as a RBC reserve management tool.

17. The financial process of claim 1 further including pairing the facility with a hybrid financial instrument.

18. The financial process of claim 17 further including pairing the facility with a hybrid financial instrument which incorporates a call/put option that qualifies a long-term debt instrument or facility for short-term pricing.

19. The financial process of claim 17 further including pairing the facility with a hybrid financial instrument selected from the group comprising the variable rate demand note, collateralized variable rate demand note, managed variable rate demand note, and combinations thereof.

20. The financial process of claim 1 further including establishing a facility with at least one investment grade institution such that the rating of the facility will translate to the financial instruments to be issued.

21. The financial process of claim 1 further including establishing a facility with at least one credit worthy financial firm for an aggregate value equal to the principal amount of debt to be undertaken plus interest amounts payable.

22. The financial process of claim 1 further including securing a lien against financing instruments, with such lien made active upon the disbursement of the corresponding reserved tender advance amount as the basis to satisfy a tender.

23. The financial process of claim 1 further including, when no further encumbrance is on the investments, returning the facility to standby until such time as another reserved tender drawing is received.

24. The financial process of claim 1 further including providing an equity component as a basis to offset risks associated with the proceeds made available.

25. The financial process of claim 24 further including providing a letter of credit as a basis to offset risks associated with the proceeds made available.

26. The financial process of claim 24 further including providing cash as a basis to offset risks associated with the proceeds made available.

27. The financial process of claim 1 further including establishing a special purpose entity for the purposes of issuing and administering financing instruments.

28. The financial process of claim 27 further including establishing a bankruptcy-remote special purpose entity for the purposes of issuing and administering financing instruments.

29. A financial process enabling an amount of financing instruments to be credit enhanced comprising:
establishing a facility with at least one firm for an aggregate value minimally equal to the principal amount of debt to be undertaken;
maintaining the facility on standby without requiring the securing of an interest against a source until such time as a drawing made there under is received;
selling financing instruments resultant from the credit enhancement afforded by the facility;
depositing proceeds from the financing instruments in at least one account from which the proceeds can be invested;
receiving a tender of the financing instruments and directing the remarketing of the financing instruments in support of the satisfaction of the tender;
remarketing the financing instruments for repurchase prior to the tender settlement date; and
if the remarketing fails prior to the tender settlement date, thus producing a shortfall of remarketing proceeds required to satisfy the tender.
submitting a draw against the facility for an amount of proceeds that equals the remarketing proceeds shortfall;
securing an interest against the eligible investments, with such security interest made active upon the disbursement of the corresponding reserved tender advance amount as the basis to satisfy the tender;
disbursing proceeds required to satisfy the tender;
holding those financing instruments that have been repurchased with proceeds derived from the facility for the benefit of the facility underwriter;
applying the remarketing proceeds to reimburse amounts drawn; and
releasing the security interest held in support of the previously advanced amount;
whereby short-term credit and liquidity are provided for the financing instruments.

30. The financial process of claim 29 further including having an option of securing an interest against a source selected from the group comprising the financing instruments, the eligible investments, and both.

31. The financial process of claim 29 further including selling financing instruments selected from the group comprising financial instruments, debt obligations, credit facilities, and combinations thereof.

32. The financial process of claim 29 further including establishing a reserved tender advance facility.

33. The financial process of claim 32 further including establishing an interim reserved tender advance facility.

34. The financial process of claim 32 further including establishing a commercial reserved tender advance facility.

35. The financial process of claim 32 further including establishing a collateralized reserved tender advance facility.

36. The financial process of claim 32 further including establishing a principal reserved tender advance facility.

37. The financial process of claim 29 further including selecting the facility from the group comprising commercial borrowers, investment funds, hedge funds, lenders, investment banks, and combinations thereof.

38. The financial process of claim 29 further including overlaying the facility into an investor that is subjected to RBC reserve requirements related to its investment portfolio.

39. The financial process of claim 29 further including the facility acting in direct association with a short-term asset management market.

40. The financial process of claim 29 further including the facility acting in support of the operation of a revolving commercial credit function.

41. The financial process of claim 40 further including the facility acting in support of operation of a warehoused credit facility.

42. The financial process of claim 29 further including the facility acting as a surrogate to asset management functionality.

43. The financial process of claim 42 further including the reserved tender advance facility acting as a surrogate to investment leverage functionality.

44. The financial process of claim 29 further including the facility acting as a surrogate to fund functionality.

45. The financial process of claim 29 further including the facility acting as a RBC reserve management tool.

46. The financial process of claim 29 further including pairing the facility with a hybrid financial instrument.

47. The financial process of claim 46 further including pairing the facility with a hybrid financial instrument which incorporates a call/put option that qualifies a long term debt instrument or facility for short-term pricing.

48. The financial process of claim 46 further including pairing the facility with a hybrid financial instrument selected from the group comprising the variable rate demand note, collateralized variable rate demand note, managed variable rate demand note, and combinations thereof.

49. The financial process of claim 29 further including establishing a facility with at least one investment grade institution such that the rating of the facility will translate to the financial instruments to be issued.

50. The financial process of claim 29 further including establishing a facility with at least one credit worthy financial finn for an aggregate value equal to the principal amount of debt to be undertaken plus interest amounts payable.

51. The financial process of claim 29 further including securing a lien against financing instruments, with such lien made active upon the disbursement of the corresponding reserved tender advance amount as the basis to satisfy the tender.

52. The financial process of claim 29 further including securing a lien against eligible investments, with such lien made active upon the disbursement of the corresponding reserved tender advance amount as the basis to satisfy the tender.

53. The financial process of claim 29 further including, when no further encumbrance is on the investments, returning the facility to standby until such time as another reserved tender drawing is received.

54. The financial process of claim 29 further including providing an equity component as a basis to offset risks associated with the proceeds made available.

55. The financial process of claim 54 further including providing a letter of credit as a basis to offset risks associated with the proceeds made available.

56. The financial process of claim 54 further including providing cash as a basis to offset risks associated with the proceeds made available.

57. The financial process of claim 29 further including establishing a special purpose entity for the purposes of issuing and administering financing instruments.

58. The financial process of claim 57 further including establishing a bankruptcy-remote special purpose entity for the purposes of issuing and administering financing instruments.

59. A financial process enabling an amount of financing instruments to be credit enhanced comprising:
an investor identifying as an investment opportunity a fund, the investor being subject to risk or loss reserve stipulations;
establishing a facility, the investor acting as a facility underwriter, the facility underwriter bearing the first-loss and principal risk associated with operation of an investment strategy of the fund;
maintaining the facility on standby without requiring the securing of an interest against a source until such time as a drawing made there under is received;
issuing at least one financing instrument resultant from credit enhancement afforded by the facility via a special purpose entity to raise proceeds and with which the operation of the facility will coordinate, the fund designated to invest or manage the proceeds in investment strategies;
the investor supporting at least one financing instrument; and
depositing proceeds from the financing instruments in at least one account from which the proceeds can be invested.

60. The financial process of claim 59 further including issuing at least one financing instrument resultant from credit enhancement afforded by the facility via a bankruptcy-remote special purpose entity to raise proceeds and with which the operation of the facility will coordinate.

61. The financial process of claim 59 further including receiving a tender of the financing instruments and directing the remarketing of the financing instruments in support of the satisfaction of the tender.

62. The financial process of claim 61 further including remarketing the financing instruments for repurchase prior to the tender settlement date.

63. The financial process of claim 62 further including, if the remarketing fails prior to the tender settlement date, thus producing a shortfall of remarketing proceeds required to satisfy the tender, submitting a draw against the facility for an amount of proceeds that equals the remarketing proceeds shortfall; having an option of securing an interest against a source selected from the group comprising the financing instruments, the eligible investments, and both, with such security interest made active upon the disbursement of the corresponding reserved tender advance amount as the basis to satisfy the tender; disbursing proceeds required to satisfy the tender, holding those financing instruments that have been repurchased with proceeds derived from the facility for the benefit of the facility underwriter, applying the remarketing proceeds to reimburse amounts drawn; and releasing the security interest held in support of the previously advanced amount.

64. The financial process of claim 59 further including, in consideration for the investor supporting the at least one financing instrument with credit enhancement and liquidity facilities, the investor receiving participation in fund yield in excess of charges and fees associated with the operation of the financing instruments.

65. The financial process of claim 59 further including subjecting the investor to risk-based capital reserve requirements.

66. The financial process of claim 65 further wherein the investor is an insurance carrier.

67. The financial process of claim 59 further including selecting the fund from the group comprising hedge funds, alternative investment managers, asset managers, fund of funds, single investment funds, multi-strategy investment fund, commercial investment managers, and combinations thereof.

68. The process of enabling an equity letter of credit comprising:
establishing a reserved tender advance facility;
establishing a reserved tender advance facility underwriter; selling financing instruments resultant from a credit enhancement afforded by the reserved tender advance facility;
granting a financial interest to enable the delivery of an equity letter of credit to the reserved tender advance facility underwriter, and
issuing to the reserved tender advance facility underwriter an equity letter of credit for at least a portion of the principal amount being credit enhanced by the operation of the reserved tender advance facility.

69. The process of enabling an equity letter of credit of claim 68 further including the issuer of the reserved tender advance facility underwriter activating the reserved tender advance facility and consenting to the commencement of fund-related operations against receipt of the equity letter of credit to cover first-losses associated with such management operations.

701. The process of enabling an equity letter of credit of claim 68 further including the issuer of the financing instrument raising financing or funds in support of a commercial operation and having a commercial alliance with an entity providing collateral to support the issuance of the equity letter of credit by a third party.

71. The process of enabling an equity letter of credit of claim 68 further including the issuer of the financing instrument raising financing or funds in support of a commercial operation and having a relationship with a financial institution which makes a suitable equity letter of credit issuer.

72. The process of enabling an equity letter of credit of claim 68 further including the equity letter of credit underwriter providing collateral to support the issuance of the equity letter of credit by a third party.

73. The process of enabling an equity letter of credit of claim 68 further including granting a security interest to enable the delivery of an operative equity letter of credit to the reserved tender advance facility underwriter.

74. The process of enabling an equity letter of credit of claim 68 further including granting financial support to enable the delivery of an operative equity letter of credit to the reserved tender advance facility underwriter.

75. The process of enabling an equity letter of credit of claim 68 further including granting a financial interest to an entity supporting issuance of the equity letter of credit to the reserved tender advance facility underwriter in the form of a yield participation in fund-related operations for which the equity letter of credit covers first-losses or principal risk.

76. The process of enabling an equity letter of credit of claim 68 further including granting a financial interest to an entity supporting issuance of the equity letter of credit to the reserved tender advance facility underwriter in the form of a yield participation in commercial operations for which the equity letter of credit covers first-losses or principal risk.

77. The process of enabling an equity letter of credit of claim 76 further including determining yield participation in the operations for which the equity letter of credit covers first-losses or principal risk after costs associated with the financing instruments.

78. The process of enabling an equity letter of credit of claim 77 further including determining yield participation in the operations for which the equity letter of credit covers first-losses or principal risk after costs selected from the group comprising interest, reserved tender advance facility fees, custodial fees, annual maintenance and administrative fees, and combinations thereof.

79. The process of enabling an equity letter of credit of claim 68 further including granting a financial interest to an entity supporting issuance of the equity letter of credit to the reserved tender advance facility underwriter in the form of a fee.

80. The process of enabling an equity letter of credit of claim 79 further including granting a financial interest to an entity supporting issuance of the equity letter of credit to the reserved tender advance facility underwriter in the form of an issuance fee.

81. The process of enabling an equity letter of credit of claim 79 further including granting a financial interest to an entity supporting issuance of the equity letter of credit to the reserved tender advance facility underwriter in the form of a collateral fee.

82. The process of enabling an equity letter of credit of claim 79 further including granting a financial interest to an entity supporting issuance of the equity letter of credit to the reserved tender advance facility underwriter in the form of an underwriting fee.

83. The process of enabling an equity letter of credit of claim 68 further including, following receipt by the reserved tender advance facility underwriter of the equity letter of credit, applying the equity letter of credit as a supplemental and contingent source of collateral upon a draw wider the reserved tender advance facility.

84. The process of enabling an equity letter of credit of claim 83 further including, following receipt by the reserved tender advance facility underwriter of the equity letter of credit, holding the equity letter of credit as undrawn, unencumbered, and on ‘standby’ until such time as actual losses associated with related fund-related operations to which the equity letter of credit applies are realized by the reserved tender advance facility underwriter.

85. The process of enabling an equity letter of credit of claim 83 further including, following receipt by the reserved tender advance facility underwriter of the equity letter of credit, holding the equity letter of credit as undrawn, unencumbered, and on ‘standby’ until such time as actual losses associated with related commercial operations to which the equity letter of credit applies are realized by the reserved tender advance facility underwriter.
